(19) United States
(12) Patent Application Publication
(10) Pub. No.: US 2022/0355662 A1
(43) Pub. Date: Nov. 10, 2022

(54) Fuel Tank Unit

(71) Applicant: AISAN KOGYO KABUSHIKI KAISHA, Obu-shi (JP)

(72) Inventor: Naohito BUSEKI, Obu-shi (JP)

(73) Assignee: AISAN KOGYO KABUSHIKI KAISHA, Obu-shi (JP)

(21) Appl. No.: 17/731,946

(22) Filed: Apr. 28, 2022

(30) Foreign Application Priority Data
May 6, 2021 (JP) 2021-078376

(51) Int. Cl. B60K 15/035; G05D 9/02

(52) U.S. Cl. CPC B60K 15/03504; G05D 9/02; B60K 2015/03256

(57) ABSTRACT

A fuel tank unit may include a fuel tank, a canister configured to adsorb and desorb vapor generated in the fuel tank, a vapor conduit communicating the fuel tank with the canister, and a full tank fuel level limiting valve device connected to a fuel tank-side end of the vapor conduit. The full tank fuel level limiting valve device includes a full tank fuel level limiting valve and an actuator. The full tank fuel level limiting valve includes a float that is configured to float due to a buoyancy force of fuel in the fuel tank so as to close the full tank fuel level limiting valve when the fuel tank is filled up. The actuator includes a valve closure prevention member that is configured to move and press the float when the actuator is activated, so as to prevent the float from moving in a valve closing direction.

### CROSS-REFERENCE TO RELATED APPLICATIONS

This application claims priority to Japanese patent application serial number 2021-078376 filed May 6, 2021, the contents of which are hereby incorporated herein by reference in its entirety for all purposes.

### BACKGROUND

The present disclosure relates generally to a fuel tank unit. More particularly, the present disclosure relates to a fuel tank unit for an automobile or other such vehicle, the fuel tank unit including a fuel tank, a canister and a full tank fuel level limiting valve.

Conventionally, a fuel tank unit for an automobile or other such vehicle includes a fuel tank, a canister configured to adsorb and desorb vapor generated in the fuel tank, a full tank fuel level limiting valve attached to the fuel tank, and a vapor conduit communicating between the fuel tank and the canister via the full tank fuel level limiting valve. The full tank fuel level limiting valve includes a housing and a float vertically movably disposed in the housing. The float is configured to float (upward) due to a buoyancy force of fuel introduced into the housing so as to close the valve when a fuel level reaches a full tank fuel level.

Generally, in the full tank fuel level limiting valve, the housing includes a fluid flow passage formed therein and positioned above the float. The fluid flow passage is configured such that fluids (such as vapor containing gases) in the fuel tank flow therethrough toward the vapor conduit. The fluid flow passage is configured such that the fluids in the fuel tank flows therethrough in a direction (horizontal direction) perpendicular to a moving direction (vertical direction) of the float.

### SUMMARY

For example, in one aspect of the present disclosure, a fuel tank unit may include a fuel tank, a canister configured to adsorb and desorb vapor generated in the fuel tank, a vapor conduit communicating between the fuel tank and the canister, and a full tank fuel level limiting valve device connected to a fuel tank-side end of the vapor conduit. The full tank fuel level limiting valve device includes a full tank fuel level limiting valve including a float that is configured to float due to a buoyancy force of fuel in the fuel tank so as to close the full tank fuel level limiting valve when the fuel tank is filled up, and an actuator configured to be activated due to a pressure difference between a tank inner pressure of the fuel tank and a pressure in the vapor conduit. The actuator includes a valve closure prevention member that is configured to move and press the float when the actuator is activated, so as to prevent the float from moving in a valve closing direction.

According to the aspect, the actuator of the full tank fuel level limiting valve device is activated due to the pressure difference between the tank inner pressure of the fuel tank and the pressure in the vapor conduit. Generally, when the pressure difference between the tank inner pressure of the fuel tank and the pressure in the vapor conduit is significantly large, a high-speed flow of the fluids is generated between the fuel tank and the vapor conduit. As a result, the float of the full tank fuel level limiting valve is subjected to a suction force due to a negative pressure caused by the high-speed flow of the fluids. However, due to the significant pressure difference, the actuator is activated to move the valve closure prevention member. As a result, the float is pressed by the valve closure prevention member. Thus, the float is prevented from moving in the valve closing direction even though the float is subjected to such a suction force. Consequently, the full tank fuel level limiting valve is effectively prevented from being closed by the float even when the high-speed flow of the fluids is generated.

Further, in another aspect of the present disclosure, a fuel tank unit may include a fuel tank, a canister configured to adsorb and desorb vapor generated in the fuel tank, a vapor conduit communicating between the fuel tank and the canister, and a full tank fuel level limiting valve device connected to a fuel tank-side end of the vapor conduit. The full tank fuel level limiting valve device includes a full tank fuel level limiting valve including a float that is configured to float due to a buoyancy force of fuel in the fuel tank so as to close the full tank fuel level limiting valve when the fuel tank is filled up, and an actuator including an electric motor that is configured to be activated based on a signal from an electronic control unit electrically connected thereto. The actuator includes a valve closure prevention member that is configured to move and press the float when the electric motor is activated, so as to prevent the float from moving in a valve closing direction.

According to the aspect, the electric motor of the actuator is activated based on the signal from the electronic control unit. Accordingly, the full tank fuel level limiting valve is effectively prevented from being closed when the high-speed flow of the fluids is generated.

Other objects, features, and advantages, of the present disclosure will be readily understood after reading the following detailed description together with the accompanying drawings and the claims.

### BRIEF DESCRIPTION OF THE DRAWINGS

FIG. 1 is a schematic diagram of a fuel tank unit having a full tank fuel level limiting valve device according to a first embodiment;

FIG. 2 is a vertical cross-sectional view of the full tank fuel level limiting valve device;

FIG. 3 is a vertical cross-sectional view of the full tank fuel level limiting valve device, which illustrates a condition in which fluids (gases) in a fuel tank flow through a fluid flow passage at high speed;

FIG. 4 is a vertical cross-sectional view of the full tank fuel level limiting valve device, which illustrates a condition in which the fluids in the fuel tank flow through the fluid flow passage at low speed;

FIG. 5 is a vertical cross-sectional view of the full tank fuel level limiting valve device, which illustrates a condition in which a fuel level reaches a fuel tank fuel level;

FIG. 6 is a vertical cross-sectional view of a full tank fuel level limiting valve device according to a second embodiment;

FIG. 7 is a vertical cross-sectional view of a full tank fuel level limiting valve device according to a third embodiment;

FIG. 8 is a flow chart of a control routine of the fuel tank unit when refueling;

FIG. 9 is a vertical cross-sectional view of a full tank fuel level limiting valve device according to a fourth embodiment;

FIG. 10 is a schematic diagram of a fuel tank unit having a full tank fuel level limiting valve device according to a fifth embodiment;

FIG. 11 is a vertical cross-sectional view of the full tank fuel level limiting valve device;

FIG. 12 is a vertical cross-sectional view of the full tank fuel level limiting valve device, which illustrates a first functional state of the full tank fuel level limiting valve device;

FIG. 13 is a vertical cross-sectional view of the full tank fuel level limiting valve device, which illustrates a condition in which a full tank fuel level limiting valve of the full tank fuel level limiting valve device is closed;

FIG. 14 is a vertical cross-sectional view of the full tank fuel level limiting valve device, which illustrates a second functional state of the full tank fuel level limiting valve device;

FIG. 15 is a flow chart of a valve control routine when refueling;

FIG. 16 is a vertical cross-sectional view of a full tank fuel level limiting valve device according to a sixth embodiment;

FIG. 17 is a vertical cross-sectional view of a full tank fuel level limiting valve device according to a seventh embodiment;

FIG. 18 is a vertical cross-sectional view of a full tank fuel level limiting valve device according to an eighth embodiment;

FIG. 19 is a vertical cross-sectional view of a full tank fuel level limiting valve device according to a ninth embodiment;

FIG. 20 is a vertical cross-sectional view of a full tank fuel level limiting valve device according to a tenth embodiment;

FIG. 21 is an enlarged partially vertical cross-sectional view of the full tank fuel level limiting valve device, which illustrates a weakened portion formed on a casing; and

FIG. 22 is a partially vertical cross-sectional view of a full tank fuel level limiting valve device according to an eleventh embodiment.

### DETAILED DESCRIPTION

As previously described, in the known full tank fuel level limiting valve, the fluid flow passage is formed in the housing. The fluid flow passage is positioned above the float. The fluids in the fuel tank flows through the fluid flow passage in the direction perpendicular to the moving direction of the float. Therefore, when the fluid flows through the fluid flow passage at high speed, the float may be unexpectedly moved or displaced to a valve closing direction (upward) due to a negative pressure caused by a high-speed flow of the fluids. Generally, the high-speed flow of the fluids in the fluid flow passage may be generated when a pressure difference between an inner pressure of the fuel tank and a pressure in the vapor conduit is significantly large, for example, during a depressurizing operation of the fuel tank prior to refueling. If the float is displaced in the valve closing direction during the depressurizing operation of the fuel tank, such a depressurizing operation cannot be smoothly performed. Thus, there is a need in the art for a fuel tank unit having an improved full tank fuel level limiting valve.

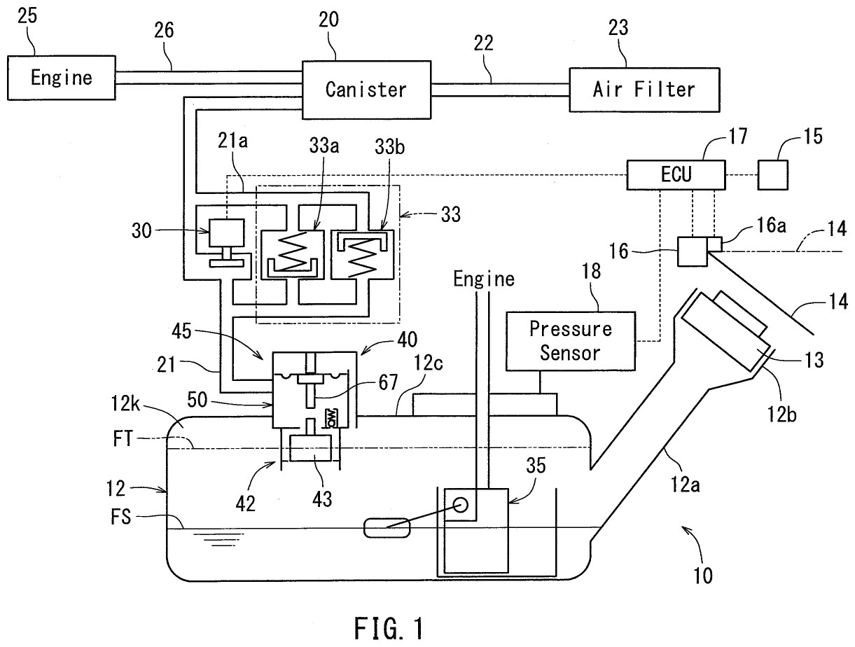

Detailed representative embodiments of the present disclosure are shown in FIG. 1 to FIG. 22.

A first detailed representative embodiment of the present disclosure will be described with reference to FIGS. 1 to 5. This embodiment is directed to a fuel tank unit for an automobile or other such vehicle equipped with an internal-combustion engine (which may be simply referred to as an engine). Referring first to FIG. 1, a fuel tank unit 10 of this embodiment is shown. As shown in FIG. 1, the fuel tank unit 10 includes a fuel tank 12, a canister 20 configured to adsorb and desorb vapor (vaporized fuel) generated in the fuel tank 12, a full tank fuel level limiting valve device 40 attached to the fuel tank 12, and a vapor conduit 21 communicating the fuel tank 12 with the canister 20 via the full tank fuel level limiting valve device 40.

As shown in FIG. 1, the fuel tank 12 has a filler pipe 12a of which a lower end is connected thereto. The filler pipe 12a has an enlarged filler pipe opening 12b formed on an upper end thereof. The filler pipe opening 12b is configured such that a fuel filling nozzle (not shown) may be inserted thereinto. Further, the filler pipe opening 12b is equipped with a detachable filler cap 13. When refueling, the filler cap 13 is detached from the filler pipe opening 12b by a refueling worker.

As shown in FIG. 1, the filler cap 13 is covered by a hinged lid 14 formed on a vehicle body panel (not shown) and normally closed and locked (shown by a solid line in FIG. 1). The lid 14 is linked to a lid opener 16, so as to be opened when the lid opener 16 is activated. In particular, the lid opener 16 is electrically connected to an ECU (electronic control unit) 17. Further, the ECU 17 is electrically connected to a lid switch 15 that is attached to an interior panel or other such panel (not shown). Therefore, when the lid switch 15 is manipulated to open the lid 14, a corresponding signal is sent to the ECU 17. Consequently, the ECU 17 controllably activates the lid opener 16 based on the signal, so that the lid 14 is unlocked. Thus, the lid 14 is opened (shown by a chain double dashed line in FIG. 1). Further, the lid opener 16 is provided with a lid sensor 16a. The lid sensor 16a is configured to detect a condition (opened or closed) of the lid 14 and to send a corresponding signal to the ECU 17.

As shown in FIG. 1, the fuel tank 12 is provided with a pressure sensor 18 (which may be referred to as a pressure detecting device) for detecting a pressure of a gas phase 12k formed in the fuel tank 12 (which may be referred to as a tank inner pressure). The pressure sensor 18 is electrically connected to the ECU 17. Therefore, a signal corresponding to the tank inner pressure detected by the pressure sensor 18 is sent to the ECU 17. Further, the fuel tank 12 is provided with a fuel-feeding device 35 disposed therein. The fuel-feeding device 35 feeds fuel in the fuel tank 12 to the engine 25 for combustion.

As shown in FIG. 1, the canister 20 includes a casing (not shown) filled with adsorbing materials (e.g., activated carbon) for adsorbing and desorbing the vapor generated in the fuel tank 12. The canister 20 is in fluid communication with the gas phase 12k of the fuel tank 12 via the vapor conduit 21. In particular, the canister 20 is connected to a first end of the vapor conduit 21. Conversely, the fuel tank 12 is connected to a second end of the vapor conduit 21 via the full tank fuel level limiting valve device 40 attached to the fuel tank 12. Further, the first end and the second end of the vapor conduit 21 may respectively be referred to as a canister-side end and a fuel tank-side end of the vapor conduit 21. Therefore, fluids or vapor containing gases generated in the fuel tank 12 are fed into the canister 20 via the vapor conduit 21. As a result, the vapor contained in the gasses is adsorbed by the adsorbing materials of the canister 20 while the remaining gases (air) are discharged to the atmosphere through an atmosphere conduit 22. Further, the atmosphere conduit 22 is configured to be used as a purge conduit through which the atmospheric air (purge air) is introduced into the canister 20 when purging. The atmosphere conduit 22 is provided with an air filter 23 that is attached to an open end thereof.

As shown in FIG. 1, the canister 20 is in fluid communication with an engine 25 via a purge conduit 26. Further, the vapor conduit 21 is provided with a shut-off valve 30. Therefore, in a condition in which the shut-off valve 30 is fully (substantially) closed, when a manifold negative pressure of the engine 25 is applied to the canister 20 through the purge conduit 26, the atmospheric air is introduced into the canister 20 through the atmosphere conduit 22. As a result, the vapor adsorbed to the adsorbing materials of the canister 20 is desorbed or purged from the adsorbing materials and is transferred to the atmospheric air, which may be referred to as a purging operation. The desorbed vapor is sent to the engine 25 with the atmospheric air through the purge conduit 26 for combustion.

The shut-off valve 30 is a motor-operated valve of which a valve opening degree (flow rate) can be controlled. The shut-off valve 30 is electrically connected to the ECU 17, so as to be controllably closed and opened by the ECU 17. When the shut-off valve 30 is in a valve opened condition, the gases contained in the fuel tank 12 are capable of flowing into the canister 20 through the vapor conduit 21. To the contrary, when the shut-off valve 30 is in a valve closed condition, the gases in the fuel tank 12 are prevented from flowing out of the fuel tank 12. Further, the shut-off valve 30 may be a solenoid valve as necessary.

As shown in FIG. 1, the vapor conduit 21 includes a bypass vapor conduit 21a bypassing the shut-off valve 30. The bypass conduit 21 is provided with a relief valve device 33. The relief valve device 33 is a spring-loaded bi-directional valve device including a positive pressure relief valve 33a and a negative pressure relief valve 33b. The positive pressure relief valve 33a and the negative pressure relief valve 33b are connected to the bypass vapor conduit 21a in parallel. Further, the positive pressure relief valve 33a and the negative pressure relief valve 33b are normally closed.

The positive pressure relief valve 33a is opened when the tank inner pressure of the fuel tank 12 is increased to a predetermined value or more, so that the fuel tank 12 is in fluid communication with the canister 20. As a result, the tank inner pressure is relieved or reduced, so that the fuel tank 12 may be prevented from being damaged. To the contrary, the negative pressure relief valve 33b is opened when the tank inner pressure of the fuel tank 12 is reduced to a predetermined value or less, so that the fuel tank 12 is in fluid communication with the canister 20. As a result, the gases contained in a portion of the vapor conduit 21 continuous with the canister 20 are introduced into the fuel tank 12, so as to increase the tank inner pressure. Thus, the tank inner pressure may be stabilized. Further, the relief valve device 33 may be integrated with the shut-off valve 30 as necessary.

The full tank fuel level limiting valve device 40 may be attached to an upper portion (e.g., an upper wall portion 12c) of the fuel tank 12. Further, the full tank fuel level limiting valve device 40 may be connected to the second end (the fuel tank-side end) of the vapor conduit 21. The full tank fuel level limiting valve device 40 includes a full tank fuel level limiting valve 42. The full tank fuel level limiting valve 42 includes a float 43 which may function as a valve body. The float 43 is configured to float due to a buoyancy force of the fuel in the fuel tank 12 so as to close the valve when the fuel tank 12 is filled up, i.e., when a fuel level FS reaches a full tank fuel level FT. When the full tank fuel level limiting valve 42 is closed by the float 43, the vapor containing gases in the fuel tank 12 are prevented from flowing into the vapor conduit 21. Further, the full tank fuel level limiting valve device 40 will be hereinafter described in detail.

Before describing the full tank fuel level limiting valve device 40, a basic operation of the fuel tank unit 10 will be described.

In a condition in which the vehicle is parked (i.e., the engine 25 is stopped), the shut-off valve 30 is closed, so that the fuel tank 12 is hermetically closed. Upon hermetic closure of the fuel tank 12, the vapor containing gases in the fuel tank 12 can be prevented from flowing toward the canister 20. Further, when the shut-off valve 30 is closed, the pressure in the fuel tank 12 is kept within an appropriate range by the positive pressure relief valve 33a and the negative pressure relief valve 33b of the relief valve device 33.

When the lid switch 15 is pressed by the refueling worker who intends to perform a refueling operation, the shut-off valve 30 is opened by the ECU 17. Thus, a depressurizing operation of the fuel tank 12 prior to a refueling operation is performed. Thereafter, when the pressure sensor 18 detects that the tank inner pressure of the fuel tank 12 is decreased to the predetermined value or less, the ECU 17 is actuated to open the lid opener 16. As a result, the lid 14 is opened. When the lid 14 is opened, the filler cap 13 can be detached from the filler pipe opening 12b by the refueling worker such that the fuel filling nozzle is inserted into the filler pipe opening 12b for performing the refueling operation.

The fuel level FS in the fuel tank 12 gradually increases by the refueling operation. Thereafter, when the fuel level FS has reached the full tank fuel level FT, the full tank fuel level limiting valve 42 is closed by the float 43. That is, a full tank fuel level limiting function by the full tank fuel level limiting valve 42 is achieved. As a result, the refueling operation is eventually stopped due to an automatic stop function of the fuel filling nozzle. Thereafter, the filler cap 13 is attached to the filler pipe opening 12b and then the lid 14 is closed. Thus, the refueling operation is completed.

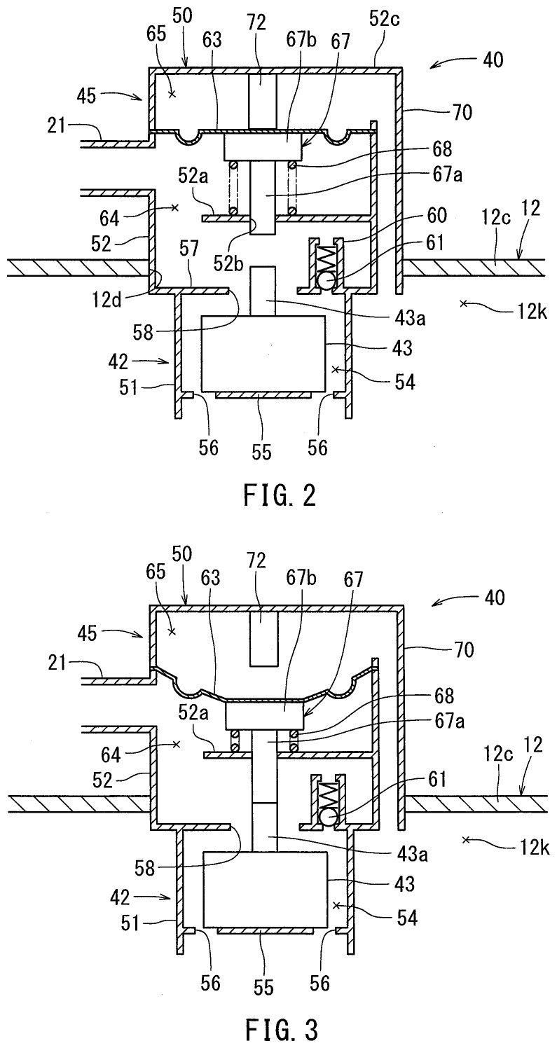

Next, the full tank fuel level limiting valve device 40 will be described. As shown in FIG. 2, the full tank fuel level limiting valve device 40 includes a diaphragm actuator 45 (which may be referred to as “an actuator”). The diaphragm actuator 45 is integrated with the full tank fuel level limiting valve 42. Further, the full tank fuel level limiting valve device 40 includes a casing 50 having an upright hollow cylindrical shape. The casing 50 is composed of a first or lower box-shape casing portion 51 having a small diameter and a second or upper casing portion 52 having a large diameter. The first casing portion 51 constitutes the full tank fuel level limiting valve 42. The second casing portion 52 constitutes the diaphragm actuator 45. The second casing portion 52 is securely and hermetically coupled to an attaching opening 12d formed on the upper wall portion 12c of the fuel tank 12 in a condition in which the first casing portion 51 is introduced into the fuel tank 12.

As shown in FIG. 2, the full tank fuel level limiting valve 42 includes a float chamber 54 formed in an interior cavity of the first casing portion 51. The float 43 of the full tank fuel level limiting valve 42 is vertically and movably positioned in the float chamber 54. The float 43 is configured to float due to the buoyancy force of the fuel in the fuel tank 12. The float 43 has a columnar shape. Further, the float 43 has a stem-like projection 43a formed on a central portion of an upper surface thereof and projecting upward. The first casing 51 has a bottom wall 55 having a plurality of communication holes 56. The communication holes 56 are configured to vertically penetrate the bottom wall 55 so as to communicate the float chamber 54 with an interior cavity of the fuel tank 12.

The first casing portion 51 and the second casing portion 52 are separated by a partition wall 57. The partition wall 57 has a through hole or valve orifice 58 into which the projection 43a of the float 43 is loosely introduced from below. The float 43 is normally lowered under its own weight, so as to be in a valve opening condition in which the valve orifice 58 is opened. As a result, the full tank fuel level limiting valve 42 is normally opened. When the fuel in the fuel tank 12 flows into the float chamber 54 of the first casing portion 51, the float 43 move upward with the buoyancy force of the fuel. When the fuel tank 12 is filled up, the float 43 closes the valve orifice 58, so that the full tank fuel level limiting valve 42 is closed (FIG. 5).

As shown in FIG. 2, the partition wall 57 includes a relief port 60 formed thereon such that the first casing portion 51 is in fluid communication with the second casing portion 52 therethrough. The relief port 60 is provided with a spring-loaded relief valve 61. The relief valve 61 is normally closed. When the tank inner pressure of the fuel tank 12 is increased to a predetermined value or more in a condition in which the valve orifice 58 is closed by the float 43, the relief valve 61 is opened, so that the fuel tank 12 is in fluid communication with the second casing portion 52. As a result, the tank inner pressure can be relieved or reduced.

As shown in FIG. 2, the diaphragm actuator 45 includes a flexible diaphragm 63, an actuator body 67 (which may be referred to as “a valve closure prevention member”) and a support spring 68. The diaphragm 63 is horizontally disposed in an interior cavity of the second casing portion 52. The diaphragm 63 divide the interior cavity of the second casing portion 52 into a lower or pressure chamber 64 and an upper or back-pressure chamber 65. Further, the second casing portion 52 is connected to the vapor conduit 21 such that the pressure chamber 64 is in fluid communication with the canister 20.

As shown in FIG. 2, the actuator body 67 is formed as a headed stem-like member having a stem portion 67a and a head portion 67b. The head portion 67b is connected to a central portion of a lower surface of the diaphragm 63. Further, the second casing portion 52 includes a support strip 52a horizontally projecting into the lower chamber 64 from a circumferential wall portion thereof in a middle portion between the diaphragm 63 and the partition wall 57. The support strip 52a has a through hole 52b into which the stem portion 67a of the actuator body 67 is movably inserted. The stem portion 67a partially projects downward through the through hole 52b. Further, a distal (lower) end surface of the stem portion 67a is positioned vertically opposite to a distal (upper) end surface of the projection 43a of the float 43.

As shown in FIG. 2, the support spring 68 is positioned between the support strip 52a and the head portion 67b of the actuator body 67. The support spring 68 is a coil spring that is journaled on the stem portion 67a of the actuator body 67. The support spring 68 is configured to elastically hold the actuator body 67 in an elevated position (a waiting or non-acting position).

As shown in FIG. 2, the second casing portion 52 includes a communicating channel 70 that is configured to communicate the gas phase 12k of the fuel tank 12 with the back-pressure chamber 65 of the second casing portion 52. Further, the second casing portion 52 includes a stopper member 72 suspended from a central portion of an upper wall 52c thereof. The stopper member 72 is configured to prevent the actuator body 67 from being excessively pushed up beyond the elevated position.

Next, an operation of the full tank fuel level limiting valve device 40 will be described. Firstly, when the shut-off valve 30 is closed (when the vehicle is parked, i.e., when the engine 25 is stopped), the gas phase 12k of the fuel tank 12 is not in fluid communication with the canister 20 (the atmosphere conduit 22) via the vapor conduit 21. Therefore, pressures within the pressure chamber 64 and the back-pressure chamber 65 separated by the diaphragm 63 are equal to each other. That is, the pressure in the pressure chamber 64 and the pressure in the back-pressure chamber 65 are respectively equal to the tank inner pressure of the fuel tank 12. As a result, as shown in FIG. 2, the actuator body 67 of the diaphragm actuator 45 is held on the elevated position. At this time, the float 43 is lowered under its own weight, so as to be positioned in a valve opening position in which the valve orifice 58 is opened.

Conversely, in order to perform the depressurizing operation of the fuel tank 12 prior to the refueling operation, the shut-off valve 30 is fully opened, so that the gas phase 12k of the fuel tank 12 is in full fluid communication with the canister 20 (the atmosphere conduit 22) via the vapor conduit 21. At this time, the tank inner pressure of the fuel tank 12 is significantly higher than atmospheric pressure (i.e., a pressure of the vapor conduit 21). Therefore, a high-speed flow of the fluids is generated in the float chamber 54 due to a significant pressure difference between the tank inner pressure of the fuel tank 12 and atmospheric pressure. As a result, the float 43 of the full tank fuel level limiting valve 42 is subjected to an upward suction force due to a negative pressure caused by the high-speed flow of the fluids. However, at this time, the pressure in the pressure chamber 64 is significantly reduced relative to the pressure in the back-pressure chamber 65. Due to a significant pressure difference between the pressure chamber 64 and the back-pressure chamber 65, the diaphragm 63 is flexed downward against a spring force of the support spring 68, so that the actuator body 67 is displaced to a lowered or acting position (FIG. 3). As a result, the stem portion 67a of the actuator body 67 contacts the projection 43a of the float 43, so that the float 43 is pressed downward by the actuator body 67. Thus, as shown in FIG. 3, the float 43 is prevented from moving upward (i.e., in a valve closing direction), so as to be held in the valve opening position. That is, the full tank fuel level limiting valve 42 is prevented from being closed. Therefore, the depressurizing operation of the fuel tank 12 can be performed under the high-speed flow of the fluids.

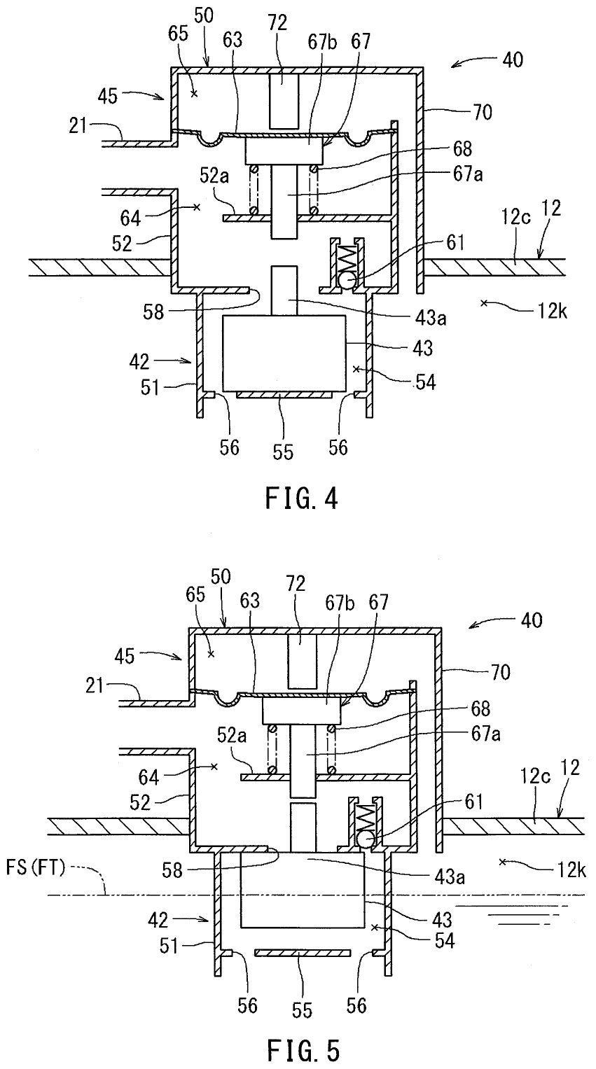

Further, when the shut-off valve 30 is restrictively opened, e.g., during the refueling operation or the purging operation, the gas phase 12k of the fuel tank 12 is in limited fluid communication with the canister 20 (the atmosphere conduit 22) via the vapor conduit 21. Therefore, only a slow-speed flow of the fluids is generated in the pressure chamber 64 because a pressure difference between the tank inner pressure of the fuel tank 12 and atmospheric pressure is relatively small. As a result, the float 43 is not substantially affected by the fluids flowing through the pressure chamber 64. In addition, at this time, the pressure in the pressure chamber 64 is only slightly less than the pressure in the back-pressure chamber 65. Therefore, the diaphragm 63 is not substantially flexed downward against the spring force of the support spring 68. That is, the actuator body 67 is not substantially displaced toward the lowered position (FIG. 4). As a result, the float 43 is not prevented from moving in the valve closing direction. Therefore, the full tank fuel level limiting valve 42 may reliably achieve the full tank fuel level limiting function. Further, the spring force of the support spring 68 may be appropriately controlled such that the actuator body 67 is not excessively displaced toward the lowered position. In addition, because the shut-off valve 30 is the motor-operated valve, the valve opening degree of the shut-off valve 30 during the purging operation can be controlled, thereby allowing appropriate control of a flow speed of the fluids.

During the refueling operation subsequent to the depressurizing operation of the fuel tank 12, the actuator body 67 is not lowered to the lowered position (FIG. 4). That is, the actuator body 67 does not prevent the float 43 from moving upward. Therefore, when the fuel level FS in the fuel tank 12 gradually increases with the progress of the refueling operation, the float 43 floats with a buoyancy force of the fuel flowing into the float chamber 54 through the communication holes 56 of the first casing 51. Thereafter, when the fuel level FS reaches the full tank fuel level FT, the float 43 closes the valve orifice 58, so that the full tank fuel level limiting valve 42 is closed (FIG. 5). Thus, the full tank fuel level limiting valve 42 may achieve the full tank fuel level limiting function.

Further, during the purging operation, the actuator body 67 is not lowered to the lowered position (FIG. 4). Therefore, if the fuel level FS in the fuel tank 12 unexpectedly fluctuates and increases during the purging operation, the float 43 quickly floats upward, so as to closes the valve orifice 58. As a result, the full tank fuel level limiting valve 42 is quickly closed. Thus, the full tank fuel level limiting valve 42 may also function as a fuel shut-off valve during the purging operation. Further, even in a circumstance other than the purging operation, the full tank fuel level limiting valve 42 may function as the fuel shut-off valve provided that the actuator body 67 is not lowered to contact the projection 43a of the float 43.

According to the embodiment, the full tank fuel level limiting valve device 40 is configured such that the diaphragm actuator 45 integrated with the full tank fuel level limiting valve 42 is activated due to a pressure difference between the tank inner pressure of the fuel tank 12 and the pressure of the vapor conduit 21. Generally, when the pressure difference between the tank inner pressure of the fuel tank 12 and the pressure of the vapor conduit 21 is significantly large, the high-speed flow of the fluids is generated in the float chamber 54. As a result, the float 43 of the full tank fuel level limiting valve 42 may be subjected to the upward suction force due to the negative pressure caused by the high-speed flow of the fluids. However, at this time, the pressure in the pressure chamber 64 is significantly reduced relative to the pressure in the back-pressure chamber 65. Due to the significant pressure difference between the pressure chamber 64 and the back-pressure chamber 65, the diaphragm 63 is flexed downward, so that the actuator body 67 is displaced to the lowered position. As a result, the float 43 is pressed downward by the actuator body 67. Thus, the float 43 is prevented from moving in the valve closing direction even though it is being subjected to the upward suction force. Consequently, the full tank fuel level limiting valve 42 is effectively prevented from being closed even when the high-speed flow of the fluids is generated in the float chamber 54. Therefore, the depressurizing operation of the fuel tank 12 prior to the refueling operation can be smoothly and quickly performed. That is, the tank inner pressure of the fuel tank 12 can be quickly reduced to atmospheric pressure. This means that the depressurizing operation of the fuel tank 12 can be performed in a short time.

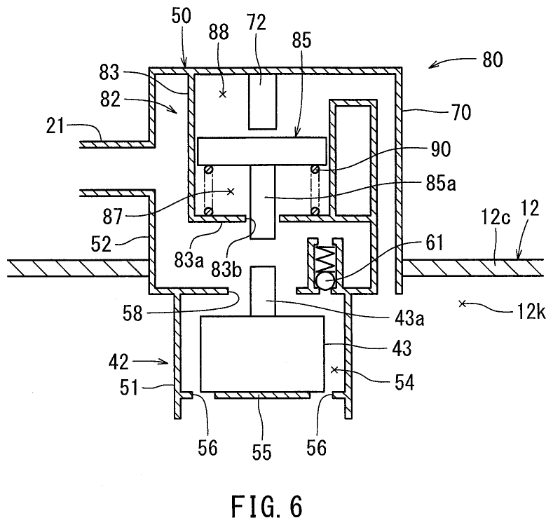

Next, a second detailed representative embodiment of the present disclosure will be described with reference to FIG. 6. Because the second embodiment relates to the first embodiment, only the constructions and elements that are different from the first embodiment will be explained in detail. In particular, this embodiment may be different from the first embodiment in that the full tank fuel level limiting valve device 40 is replaced with a full tank fuel level limiting valve device 80. Therefore, only the constructions and elements that are different from the first embodiment will be hereinafter explained.

As shown in FIG. 6, in the full tank fuel level limiting valve device 80 of the second embodiment, the diaphragm actuator 45 is replaced with an air cylinder 82 (which may be referred to as “the actuator”). The air cylinder 82 includes a vertical cylinder 83, a piston 85 (which may be referred to as “the valve closure prevention member”) and a support spring 90. The cylinder 83 is integrally and concentrically formed with the second casing portion 52 of the casing 50. The cylinder 83 includes a bottom wall 83a having a through hole 83b formed therethrough. The through hole 83b is formed on a central portion of the bottom wall 83a. The piston 85 is concentrically, vertically and movably disposed in the cylinder 83. The piston 85 is configured to divide an interior cavity of the cylinder 83 into a lower or pressure chamber 87 and an upper or back-pressure chamber 88. The pressure chamber 87 is in fluid communication with the float chamber 54 and the vapor conduit 21 via the through hole 83b of the cylinder 83. Further, the back-pressure chamber 88 is in fluid communication with the communicating channel 70.

The piston 85 has a stem portion 85a formed on a central portion thereof and projected downward therefrom. The stem portion 85a is loosely inserted into the through hole 83b formed on the bottom wall 83a of the cylinder 83 and extends into the second casing portion 52 through the through hole 83b. Further, a distal (lower) end surface of the stem portion 85a is positioned vertically opposite to the distal (upper) end surface of the projection 43a of the float 43.

The support spring 90 is positioned between the bottom wall 83a of the cylinder 83 and the piston 85. The support spring 90 is a coil spring that is journaled on the stem portion 85a of the piston 85. The support spring 90 is configured to elastically hold the piston 85 on the elevated position (the waiting position).

The full tank fuel level limiting valve device 80 of the second embodiment has substantially the same function and effects as the full tank fuel level limiting valve device 40 of the first embodiment. As a result, a fuel tank unit (not shown) of this embodiment having the full tank fuel level limiting valve device 80 may have the same function and effects as the fuel tank unit 10 of the first embodiment.

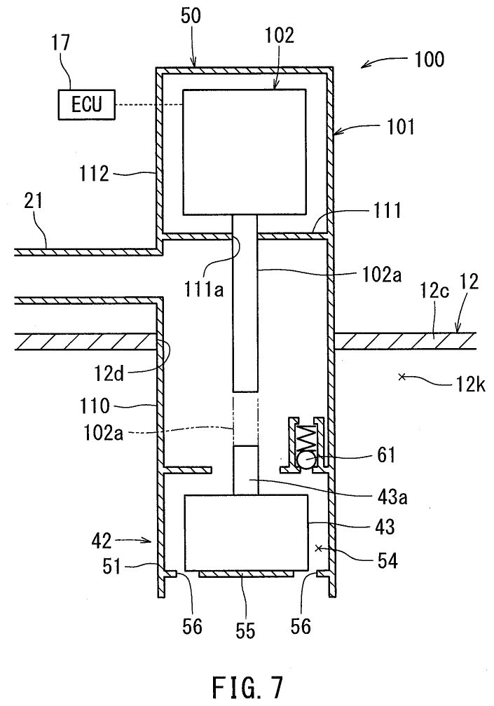

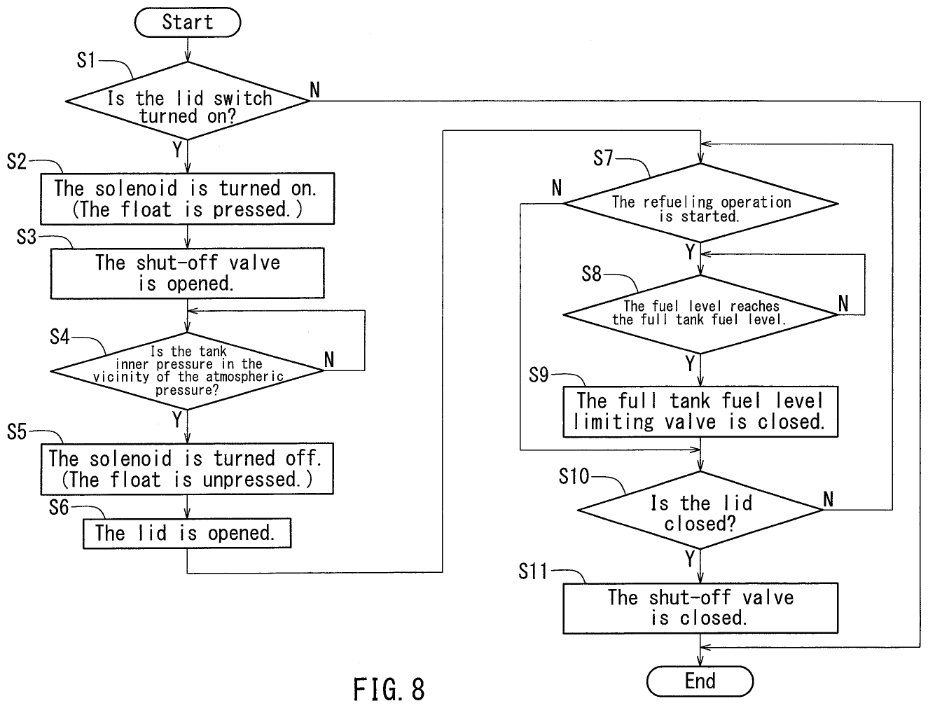

Next, a third detailed representative embodiment of the present disclosure will be described with reference to FIGS. 7 and 8. Because the third embodiment relates to the first embodiment, only the constructions and elements that are substantially different from the first embodiment will be explained in detail. In particular, this embodiment may be different from the first embodiment in that the full tank fuel level limiting valve device 40 is replaced with a full tank fuel level limiting valve device 100. Therefore, only the constructions and elements that are different from the first embodiment will be hereinafter explained.

As shown in FIG. 7, in the full tank fuel level limiting valve device 100 of the third embodiment, the diaphragm actuator 45 is replaced with an electrically driven actuator 101 (which may be simply referred to as “the actuator”). The electrically driven actuator includes a linear solenoid 102 (which may be referred to as “an electric motor”). Further, in this embodiment, the casing 50 is partially modified. In particular, the casing 50 of this embodiment includes a second or mid casing portion 110 and a third or upper casing portion 112 in place of the second casing portion 52 of the first embodiment. Further, the first casing portion 51, the second casing portion 110 and the third casing portion 112 may have substantially the same diameter as each other. The third casing portion 112 is separated from the second casing portion 110 by a partition wall 111 having a through hole 111a. The second casing portion 110 is securely and hermetically coupled to the attaching opening 12d formed in the upper wall portion 12c of the fuel tank 12 in a condition in which the first casing portion 51 is introduced into the fuel tank 12. Further, the second casing portion 110 is connected to the vapor conduit 21 so as to allow fluid communication therebetween.

The linear solenoid 102 is disposed in the third casing portion 112. The linear solenoid 102 includes an axially (vertically) movable plunger 102a (which may be referred to as “the valve closure prevention member”). The plunger 102a is projected downward from the linear solenoid 102 and extends into the second casing portion 52 through the through hole 111a of the partition wall 111. Further, a distal (lower) end surface of the plunger 102a is positioned vertically opposite to the distal (upper) end surface of the projection 43a of the float 43.

The linear solenoid 102 is, for example, a push-pull linear solenoid that is configured to move the plunger 102a between an elevated position (a waiting or non-acting position) and a lowered position (an acting position). Further, the linear solenoid 102 is electrically connected to the ECU 17 so as to be ON/OFF controlled based on the signal from the ECU 17.

In a condition in which the plunger 102a is positioned on the elevated or non-acting position (shown by solid lines in FIG. 7), when the linear solenoid 102 is turned on or energized by the ECU 17, the plunger 102a is displaced to the lowered or acting position (shown by chain double dashed lines in FIG. 7). As a result, the plunger 102a contacts the projection 43a of the float 43, so that the float 43 is pressed downward by the plunger 102a. Thus, even if the high-speed flow of the fluids is generated in the float chamber 54 due to opening of the shut-off valve 30, the float 43 is prevented from moving upward (i.e., in the valve closing direction), so as to be held in the valve opening position. That is, the full tank fuel level limiting valve 42 is prevented from being closed. Therefore, the depressurizing operation of the fuel tank 12 can be performed under the high-speed flow of the fluids. Conversely, when the linear solenoid 102 is turned off or de-energized, the plunger 102a may be returned to the elevated or non-acting position, so as to be spaced apart from the float 43. This may allow the float 43 to move in the valve closing direction.

Next, a control routine of the fuel tank unit 10 having the full tank fuel level limiting valve device 100 when refueling will be described with reference to FIG. 8. First, the ECU 17 determines whether the lid switch 15 is pressed or turned on (Step S1). When the lid switch 15 is turned on, the ECU 17 energizes or turns on the linear solenoid 102 such that the float 43 is pressed by the plunger 102a (Step S2). Subsequently, the ECU 17 opens the shut-off valve 30 (Step S3).

Thereafter, the ECU 17 determines whether the tank inner pressure of the fuel tank 12 detected by the pressure sensor 18 is in the vicinity of atmospheric pressure (Step S4). When the detected tank inner pressure is around atmospheric pressure, the ECU 17 de-energizes or turns off the linear solenoid 102 such that the plunger 102a is spaced apart from the float 43 (Step S5). Next, the ECU 17 activates the lid opener 16, so that the lid 14 is unlocked and opened (Step S6).

Thereafter, the refueling operation is started using the fuel filling nozzle (Step S7). Upon progress of the refueling operation, the fuel level FS reaches the full tank fuel level FT (Step S8). As a result, the full tank fuel level limiting valve 42 is closed by the float 43 (Step S9). When the full tank fuel level limiting valve 42 is closed, the tank inner pressure of the fuel tank 12 is increased. Eventually, the refueling operation is stopped due to the automatic stop function of the fuel filling nozzle. Next, the ECU 17 determines whether the lid 14 is closed based on the signal from the lid sensor 16a (Step S10). When the lid 14 is closed, the ECU 17 closes the shut-off valve 30 (Step S11).

According to the third embodiment, when the lid switch 15 is turned on in order to open the lid 14, the linear solenoid 102 of the full tank fuel level limiting valve device 100 is energized based on the signal from the lid switch 15. As a result, the float 43 of the full tank fuel level limiting valve 42 is pressed downward by the plunger 102a of the linear solenoid 102. Thus, the float 43 is prevented from moving in the valve closing direction even if it is being subjected to the upward suction force. Consequently, the full tank fuel level limiting valve 42 is effectively prevented from being closed even when the high-speed flow of the fluids is generated in the float chamber 54. Therefore, the depressurizing operation of the fuel tank 12 prior to the refueling operation can be smoothly and quickly performed. That is, the tank inner pressure of the fuel tank 12 can be quickly reduced to atmospheric pressure. This means that the depressurizing operation of the fuel tank 12 can be performed in a short time.

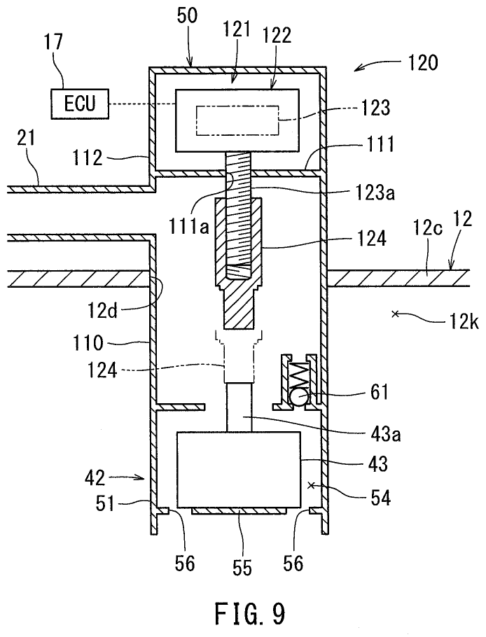

Next, a fourth detailed representative embodiment of the present disclosure will be described with reference to FIG. 9. Because the fourth embodiment relates to the third embodiment, only the constructions and elements that are different from the third embodiment will be explained in detail. In particular, this embodiment may be different from the third embodiment in that the full tank fuel level limiting valve device 100 is replaced with a full tank fuel level limiting valve device 120. Therefore, only the constructions and elements that are different from the third embodiment will be hereinafter explained.

As shown in FIG. 8, in the full tank fuel level limiting valve device 120 of the fourth embodiment, the electrically driven actuator 101 is replaced with a different type electrically driven actuator 121 (which may be simply referred to as “the actuator”). The electrically driven actuator 121 includes an electric rotary motor 122 (which may be referred to as “the electric motor”) disposed in the third casing portion 112 and having a bottomed sleeve-shaped float contact member 124 (which may be referred to as “the valve closure prevention member”).

The rotary motor 122 includes a rotor 123 and a threaded shaft 123a rotatable with the rotor 123. The threaded shaft 123a projects downward from the rotor 123 and extends into the second casing portion 110 through the through hole 111a of the partition wall 111. Further, the threaded shaft 123a may be an output shaft of the rotary motor 122. The float contact member 124 is screwed on the threaded shaft 123a from below. The float contact member 124 is held on the second casing portion 110 so as to be vertically movable without rotating around an axis thereof when the threaded shaft 123a is rotated by the rotary motor 122. A distal (lower) end surface of the float contact member 124 is positioned vertically opposite to the distal (upper) end surface of the projection 43a of the float 43. Further, the rotary motor 122 is electrically connected to the ECU 17, so as to be controlled based on the signal from the ECU 17. In particular, the rotary motor 122 is controlled such that the float contact member 124 can be moved between an elevated position (a waiting or non-acting position) and a lowered position (an acting position) via the threaded shaft 123a.

As shown in FIG. 9, in a condition in which the float contact member 124 is positioned on the elevated or non-acting position (shown by solid lines in FIG. 9), when the rotary motor 122 is rotated in a forward direction, the float contact member 124 is displaced to the lowered or acting position (shown by chain double dashed lines in FIG. 9). As a result, the float contact member 124 contacts the projection 43a of the float 43, so that the float 43 is pressed downward by the float contact member 124. Thus, even if the high-speed flow of the fluids is generated in the float chamber 54 due to opening of the shut-off valve 30, the float 43 is prevented from moving upward (i.e., in the valve closing direction), so as to be held on the valve opening position. That is, the full tank fuel level limiting valve 42 is prevented from being closed. Therefore, the depressurizing operation of the fuel tank 12 can still be performed under the high-speed flow of the fluids. Conversely, when the rotary motor 122 is rotated in a reverse direction, the float contact member 124 is returned to the elevated or non-acting position, so as to be spaced apart from the float 43. This may allow the float 43 to move in the valve closing direction.

The full tank fuel level limiting valve device 120 of the fourth embodiment has the same function and effects as the full tank fuel level limiting valve device 100 of the third embodiment.

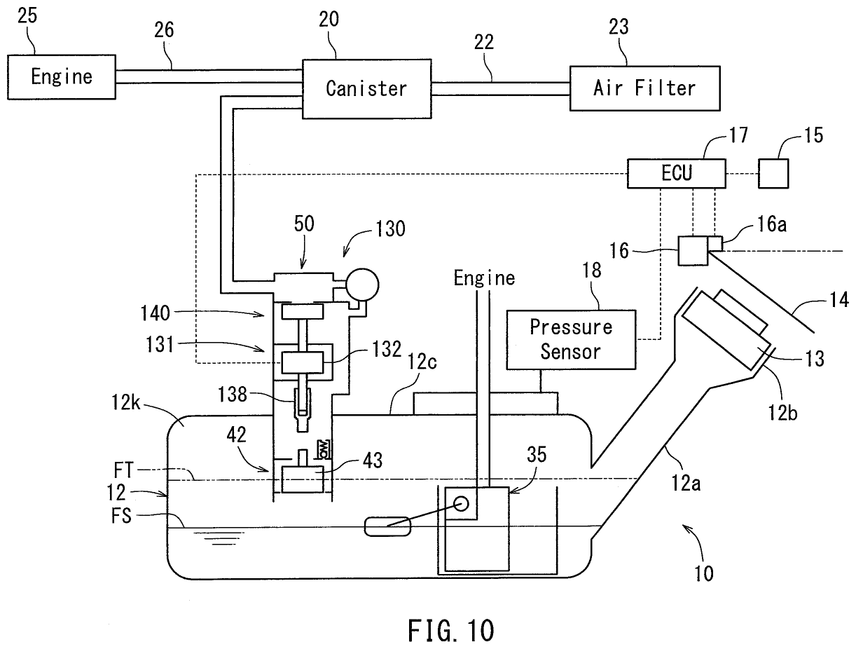

Next, a fifth detailed representative embodiment of the present disclosure will be described with reference to FIGS. 10 to 15. Because the fifth embodiment relates to the first embodiment, only the constructions and elements that are different from the first embodiment will be explained in detail. In particular, as shown in FIG. 10, this embodiment may be different from the first embodiment in that the full tank fuel level limiting valve device 120 is replaced with a full tank fuel level limiting valve device 130. Further, unlike the first embodiment, the shut-off valve 30 and the relief valve device 33 disposed on the vapor conduit 21 are omitted.

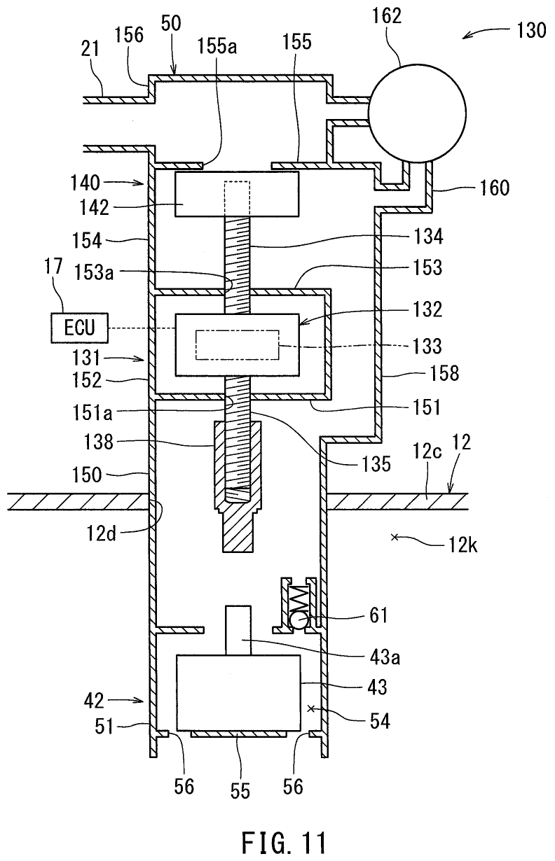

As shown in FIG. 11, in the full tank fuel level limiting valve device 130 of the fifth embodiment, the casing 50 is modified. In particular, the casing 50 of this embodiment includes a second casing portion 150, a third casing portion 152, a fourth casing portion 154 and a fifth casing portion 156 in place of the second casing portion 52 of the first embodiment. Further, the first to fifth casing portions 51, 150, 152, 154, 156 are arranged in this order from downward to upward. The second casing portion 150 is securely and hermetically coupled to the attaching opening 12d formed on the upper wall portion 12c of the fuel tank 12 in a condition in which the first casing portion 51 is introduced into the fuel tank 12. Further, the fifth casing portion 156 is connected to the vapor conduit 21 so as to be in fluid communication with each other.

The third casing portion 152 is formed between the second casing portion 150 and the fourth casing portion 154 while being isolated therefrom. The third casing portion 152 is separated from the second casing portion 150 by a partition wall 151 having a through hole 151a. The third casing portion 152 is separated from the fourth casing portion 154 by a partition wall 153 having a through hole 153a. The fourth casing portion 154 is separated from the fifth casing portion 156 by a partition wall 155 having a through hole or valve orifice 155a. Further, the second casing portion 150 and the fourth casing portion 154 are in fluid communication with each other via a communicating channel 158. Thus, a communication passage communicating between the fuel tank 12 and the vapor conduit 21 is formed in the casing 50. Further, the fourth casing portion 154 and the fifth casing portion 156 are in fluid communication with each other via a bypass conduit 160. The bypass conduit 160 is provided with a relief valve device 162, which has the same structure as the relief valve device 33 (FIG. 1) of the first embodiment.

As shown in FIG. 11, in the full tank fuel level limiting valve device 130 of the fifth embodiment, the diaphragm actuator 45 of the first embodiment is replaced with an electrically driven actuator 131 (which may be simply referred to as “the actuator”). In addition, the full tank fuel level limiting valve device 130 includes a shut-off valve 140 for opening and closing the vapor conduit 21. The electrically driven actuator 131 includes an electric rotary motor 132 (which may be referred to as “the electric motor”) disposed in the third casing portion 152 and including a bottomed sleeve-shaped float contact member 138 (which may be referred to as “the valve closure prevention member”).

The rotary motor 132 includes a rotor 133, a first or upper threaded shaft 134 rotatable with the rotor 133, and a second or lower threaded shaft 135 rotatable with the rotor 133. The upper threaded shaft 134 and the lower threaded shaft 135 are the same as each other in helical direction (right or left). The upper threaded shaft 134 projects upward from the rotor 133 and extends into the fourth casing portion 154 through the through hole 153a of the partition wall 153. Conversely, the lower threaded shaft 135 projects downward from the rotor 133 and extends into the second casing portion 150 through the through hole 151a of the partition wall 151. Further, at least one of the upper threaded shaft 134 and the lower threaded shaft 135 may be a threaded output shaft of the rotary motor 132.

The float contact member 138 is screwed on the lower threaded shaft 135 from below. The float contact member 138 is held on the second casing portion 150 so as to be vertically movable without rotating around an axis thereof. Therefore, upon forward and reverse rotation of the lower threaded shaft 135, the float contact member 138 moves upward and downward, so as to move toward and away from the float 43. Further, a distal (lower) end surface of the float contact member 138 is positioned vertically opposite to the distal (upper) end surface of the projection 43a of the float 43.

The shut-off valve 140 includes a disk-shaped valve body 142 and a valve seat. Further, in this embodiment, the partition wall 155 positioned between the fourth casing portion 154 and the fifth casing portion 156 is used as the valve seat of the shut-off valve 140. The valve body 142 is disposed in the fourth casing portion 154 and is screwed on the upper threaded shaft 134. The valve body 142 is held on the fourth casing portion 150 so as to be vertically movable without rotating around an axis thereof. Further, the valve body 142 is configured such that an upper surface thereof is aligned with the valve orifice 155a of the partition wall 155. Therefore, upon forward and reverse rotation of the upper threaded shaft 134, the valve body 142 moves upward and downward, so as to move toward and away from (i.e., close and open) the valve orifice 155a. Thus, the valve body 142 functions to control an opening area or effective sectional area of the communication passage communicating the fuel tank 12 with the vapor conduit 21.

The rotary motor 132 is electrically connected to the ECU 17, so as to be controlled based on the signal from the ECU 17. When the rotary motor 132 is activated, the float contact member 138 moves between an elevated position (a waiting or non-acting position) and a lowered position (an acting position) via the lower threaded shaft 135 while the valve body 142 of the shut-off valve 140 moves toward and away from the partition wall 155 (the valve orifice 155a) between an elevated position (a valve closing position) and a lowered position (a valve opening position). That is, the rotary motor 132 functions as a common drive source of the float contact member 138 and the valve body 142 (the shut-off valve 140). Further, upon activation of the rotary motor 132, the float contact member 138 moves in the same direction as the valve body 142 because the helical direction of the upper threaded shaft 134 is the same as the lower threaded shaft 135.

Next, an operation of the full tank fuel level limiting valve device 130 will be described. First, as shown in FIG. 11, when the vehicle is parked (when the engine 25 is stopped), the full tank fuel level limiting valve device 130 is in an initial condition. In the initial condition of the full tank fuel level limiting valve device 130, the float contact member 138 is positioned on the elevated position (the waiting or non-acting position). Conversely, the valve body 142 is positioned on the valve closing position, so that the shut-off valve 140 is in a fully closed condition. In this condition, the float 43 of the full tank fuel level limiting valve 42 is not pressed by the float contact member 138. That is, the float 43 may close the valve orifice 58 of the partition wall 57. Therefore, the full tank fuel level limiting valve 42 may function as the fuel shut-off valve.

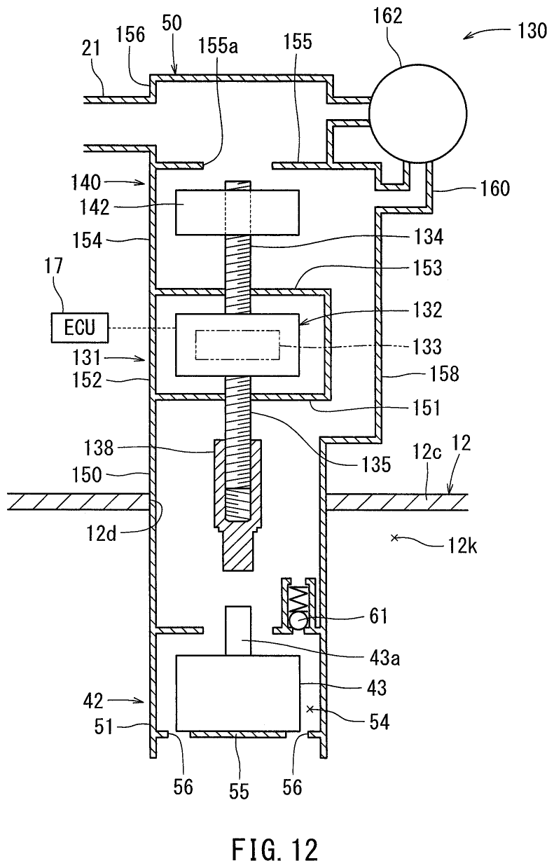

As shown in FIG. 12, when the depressurizing operation of the fuel tank 12 is performed while the vehicle is moving (when the engine is running or when the purging operation is performed), the rotary motor 132 is activated in a forward direction, such that the float contact member 138 and the valve body 142 are respectively slightly lowered to first lowered positions. As a result, the valve orifice 155a of the partition wall 155 is opened to a limited extent by the valve body 142, so that the shut-off valve 140 reaches to a half-opened condition. Therefore, the effective sectional area of the communication passage communicating between the fuel tank 12 and the vapor conduit 21 is small. As a result, only a slow-speed flow of the fluids is generated in the float chamber 54 (the communication passage). Therefore, the float 43 is not substantially subjected to an upward suction force caused by the flow of the fluids, so as to be held in place. This condition may be referred to as a first operating condition of the full tank fuel level limiting valve device 130.

Further, as shown in FIG. 12, in this condition, the float 43 is not pressed downward by the float contact member 138. Therefore, if the fuel level FS in the fuel tank 12 unexpectedly fluctuates and increases, the float 43 may quickly float upward, so as to closes the valve orifice 58. That is, the full tank fuel level limiting valve 42 may still function as the fuel shut-off valve.

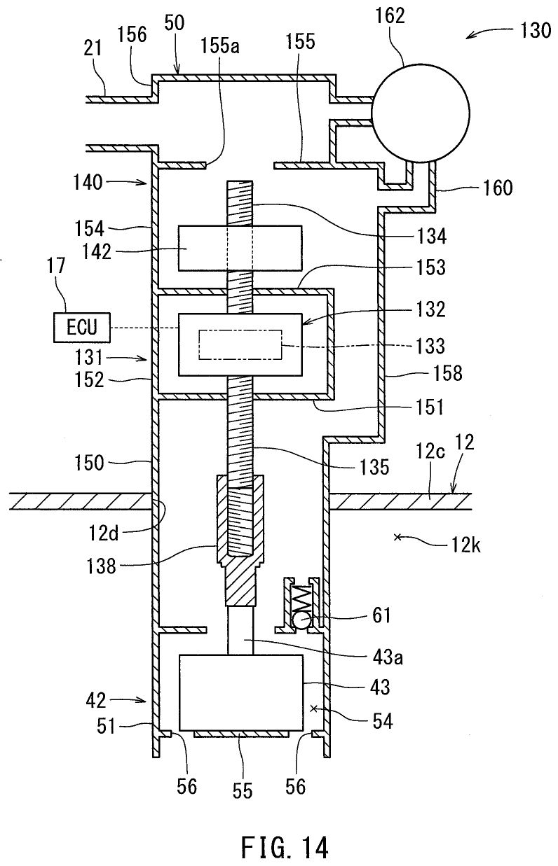

As shown in FIG. 14, in order to perform the depressurizing operation of the fuel tank 12 prior to the refueling operation, the rotary motor 132 is further activated in the forward direction, such that the float contact member 138 and the valve body 142 are respectively fully or sufficiently lowered to second lowered positions. As a result, the valve orifice 155a of the partition wall 155 is fully opened by the lowered valve body 142, so that the shut-off valve 140 reaches to a fully opened condition. Therefore, the effective sectional area of the communication passage communicating between the fuel tank 12 and the vapor conduit 21 is maximized. As a result, a high-speed flow of the fluids may be generated in the float chamber 54 (the communication passage). Therefore, the float 43 may be subjected to a large upward suction force caused by the flow of the fluids. However, the lowered float contact member 138 contacts the projection 43a of the float 43, so that the float 43 is pressed downward thereby. Thus, the float 43 is prevented from moving upward (i.e., in the valve closing direction), so as to be held on the valve opening position. That is, the full tank fuel level limiting valve 42 is prevented from being closed even though the high-speed flow of the fluids is generated in the float chamber 54. Therefore, the depressurizing operation of the fuel tank 12 can be performed under the high-speed flow of the fluids. This condition may be referred to as a second operating condition of the full tank fuel level limiting valve device 130.

When the depressurizing operation of the fuel tank 12 prior to the refueling operation is completed (i.e., when the tank inner pressure is reduced to atmospheric pressure), the rotary motor 132 is activated in a reverse direction such that the float contact member 138 and the lowered valve body 142 are respectively lifted up to the first lowered positions thereof. As a result, the shut-off valve 140 returns to the half-opened condition. Conversely, the float contact member 138 is spaced apart from the projection 43a of the float 43 (FIG. 12). Thus, the refueling operation can be performed while flowing the vapor generated in the fuel tank 12 to the canister 20 (FIG. 10).

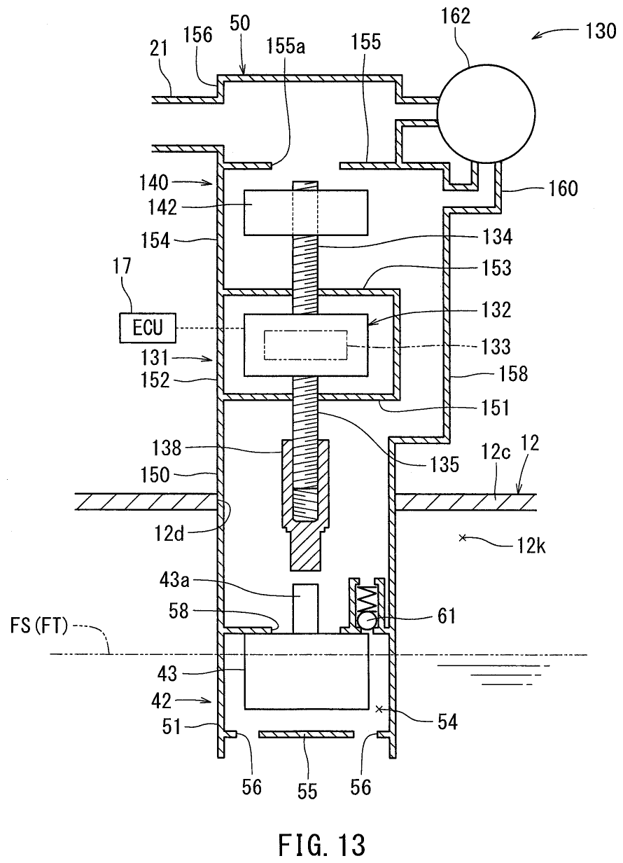

As shown in FIG. 13, when the fuel level FS in the fuel tank 12 reaches the full tank fuel level FT with the progress of the refueling operation, the float 43 closes the valve orifice 58, so that the full tank fuel level limiting valve 42 is closed. Thus, the full tank fuel level limiting function of the full tank fuel level limiting valve 42 may be achieved.

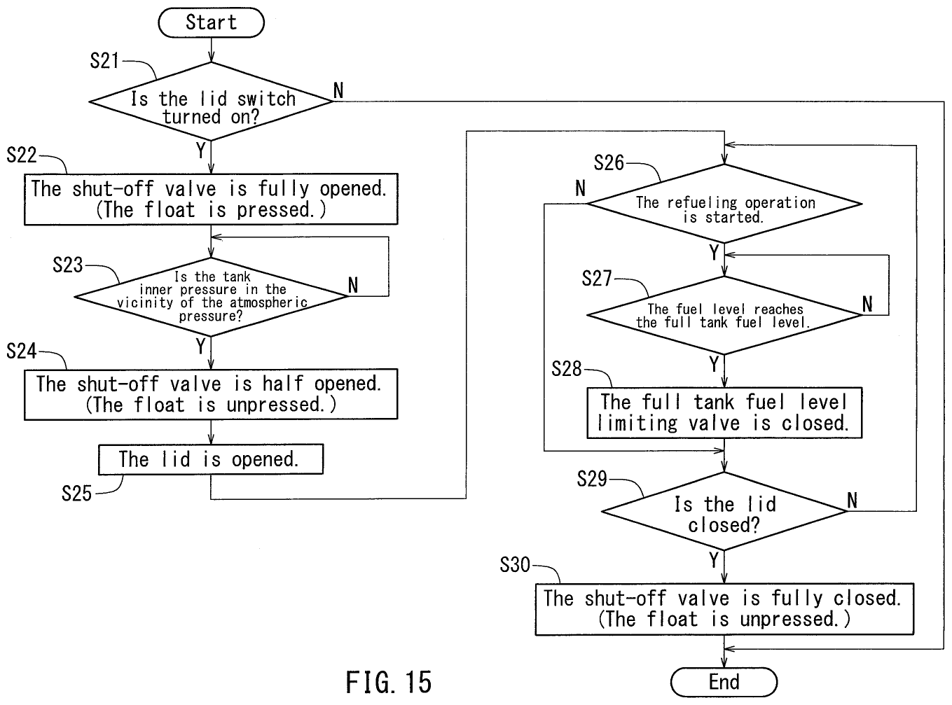

Next, a control routine of the fuel tank unit 10 having the full tank fuel level limiting valve device 130 when refueling will be described with reference to FIG. 15. First, the ECU 17 determines whether the lid switch 15 is pressed or turned on (Step S21). When the lid switch 15 is turned on, the ECU 17 activates the rotary motor 132 in the forward direction until the shut-off valve 140 reaches to the fully opened condition and the float contact member 138 presses the float 43 downward (Step S22). Thus, the full tank fuel level limiting valve device 130 reaches a condition corresponding to the depressurizing operation prior to the refueling operation shown in FIG. 14 (i.e., the second operating condition).

Thereafter, the ECU 17 determines whether the tank inner pressure of the fuel tank 12 detected by the pressure sensor 18 is in the vicinity of atmospheric pressure (Step S23). When the detected tank inner pressure is around atmospheric pressure, the ECU 17 activates the rotary motor 132 in the reverse direction such that the shut-off valve 140 returns to the half-opened condition while the float contact member 138 moves upward so as to be spaced apart from the float 43 (Step S24). Thus, the full tank fuel level limiting valve device 130 reaches to a condition corresponding to the refueling operation shown in FIG. 12 (i.e., the first operating condition).

Next, the ECU 17 activates the lid opener 16, so that the lid 14 is unlocked and opened (Step S25). Thereafter, the refueling operation may be started using the fuel filling nozzle (Step S26). Upon progress of the refueling operation, the fuel level FS reaches the full tank fuel level FT (Step S27). As a result, the full tank fuel level limiting valve 42 is closed by the float 43 (Step S28). When the full tank fuel level limiting valve 42 is closed, the tank inner pressure of the fuel tank 12 is increased. Eventually, the refueling operation is stopped due to the automatic stop function of the fuel filling nozzle.

Next, the ECU 17 determines whether the lid 14 is closed based on the signal from the lid sensor 16a (Step S29). When the lid 14 is closed, the ECU 17 activates the rotary motor 132 in the reverse direction so as to return the full tank fuel level limiting valve device 130 to the initial condition shown in FIG. 11 (Step S30).

According to the fifth embodiment, when the lid switch 15 is turned on in order to open the lid 14, the rotary motor 132 of the full tank fuel level limiting valve device 130 is activated based on the signal from the lid switch 15. As a result, the float 43 of the full tank fuel level limiting valve 42 is pressed downward by the float contact member 138. Thus, the float 43 is prevented from moving in the valve closing direction even if it is being subjected to the upward suction force. Consequently, the full tank fuel level limiting valve 42 is effectively prevented from being closed even if the high-speed flow of the fluids is generated in the float chamber 54. Further, the shut-off valve 140 is closed and opened due to activation of the rotary motor 132. Therefore, the depressurizing operation of the fuel tank 12 prior to the refueling operation can be smoothly and quickly performed. That is, the tank inner pressure of the fuel tank 12 can be quickly reduced to atmospheric pressure. This means that the depressurizing operation of the fuel tank 12 can be performed in a short time.

In the fifth embodiment, the rotary motor 132 (the electrically driven actuator 131) may function as a drive source of the shut-off valve 140. Therefore, the full tank fuel level limiting valve device 130 (the fuel tank unit 10) can be structurally simplified.

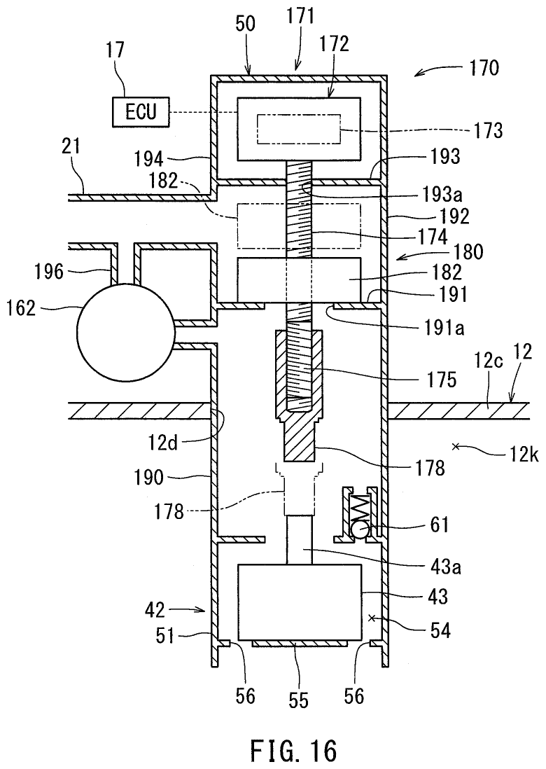

Next, a sixth detailed representative embodiment of the present disclosure will be described with reference to FIG. 16. Because the sixth embodiment relates to the fifth embodiment, only the constructions and elements that are different from the fifth embodiment will be explained in detail. In particular, as shown in FIG. 16, this embodiment may be different from the fifth embodiment in that the full tank fuel level limiting valve device 130 is replaced with a full tank fuel level limiting valve device 170.

As shown in FIG. 16, in the full tank fuel level limiting valve device 170 of the sixth embodiment, the casing 50 is modified. In particular, in the casing 50 of this embodiment, the second casing portion 150, the third casing portion 152, the fourth casing portion 154 and the fifth casing portion 156 of the fifth embodiment are replaced with a second casing portion 190, a third casing portion 192 and a fourth casing portion 194. Further, the first to fourth casing portions 51, 190, 192, 194 are arranged in this order from downward to upward. The second casing portion 190 is securely and hermetically coupled to the attaching opening 12d formed on the upper wall portion 12c of the fuel tank 12 in a condition in which the first casing portion 51 is introduced into the fuel tank 12. Further, unlike the fifth embodiment, the third casing portion 192 is in fluid communication with the vapor conduit 21. Further, the second casing portion 190 is in fluid communication with the vapor conduit 21 via a bypass conduit 196. The bypass conduit 196 is provided with the relief valve device 162.

The third casing portion 192 is formed between the second casing portion 190 and the fourth casing portion 194. The third casing portion 192 is separated from the second casing portion 190 by a partition wall 191 having a through hole or valve orifice 191a. The valve orifice 191a constitutes a portion of the communication passage communicating between the fuel tank 12 and the vapor conduit 21. Further, the third casing portion 192 is separated from the fourth casing portion 194 by a partition wall 193 having a through hole 193a.

As shown in FIG. 16, in the full tank fuel level limiting valve device 170 of the sixth embodiment, the electrically driven actuator 131 of the fifth embodiment is replaced with an electrically driven actuator 171 (which may be simply referred to as “the actuator”). In addition, the full tank fuel level limiting valve device 170 includes a shut-off valve 180. The electrically driven actuator 171 includes an electric rotary motor 172 (which may be referred to as “the electric motor”) disposed in the fourth casing portion 194 and including a bottomed sleeve-shaped float contact member 178 (which may be referred to as “the valve closure prevention member”).

The rotary motor 172 includes a rotor 173, a first or upper threaded shaft 174 rotatable with the rotor 173, and a second or lower threaded shaft 175 connected to a distal end of the upper threaded shaft 174 and rotatable with the rotor 173. The upper threaded shaft 174 and the lower threaded shaft 175 are different from each other in helical direction (right or left). The upper threaded shaft 174 is projected downward from the rotor 173 and extends into the third casing portion 192 through the through hole 193a of the partition wall 193. The upper threaded shaft 174 further extends downward and is introduced into the second casing portion 190 through the valve orifice 191a such that the lower threaded shaft 175 connected thereto is positioned in the second casing portion 190. Further, the upper threaded shaft 174 may be a threaded output shaft of the rotary motor 172.

The float contact member 178 is screwed on the lower threaded shaft 175 from below. The float contact member 178 is held on the second casing portion 190 so as to be vertically movable without rotating around an axis thereof. Therefore, upon forward and reverse rotation of the lower threaded shaft 175, the float contact member 178 moves upward and downward, so as to move toward and away from the float 43. Further, a distal (lower) end surface of the float contact member 178 is positioned vertically opposite to the distal (upper) end surface of the projection 43a of the float 43.

The shut-off valve 180 includes a disk-shaped valve body 182 and a valve seat. Further, in this embodiment, the partition wall 191 positioned between the second casing portion 190 and the third casing portion 192 is used as the valve seat of the shut-off valve 180. The valve body 182 is disposed in the third casing portion 192 and screwed on the upper threaded shaft 174. The valve body 182 is held on the third casing portion 192 so as to be vertically movable without rotating around an axis thereof. Therefore, upon forward and reverse rotation of the upper threaded shaft 174, the valve body 182 moves upward and downward, so as to move toward and away from (i.e., close and open) the valve orifice 191a. Thus, the valve body 182 functions to control an opening area or effective sectional area of the communication passage communicating between the fuel tank 12 and the vapor conduit 21.

The rotary motor 172 is electrically connected to the ECU 17, so as to be controlled based on the signal from the ECU 17. When the rotary motor 172 is activated, the float contact member 178 moves between an elevated position (a waiting or non-acting position) and a lowered position (an acting position) via the lower threaded shaft 175 while the valve body 182 of the shut-off valve 180 moves toward and away from the partition wall 191 (the valve orifice 191a) between an elevated position (a valve opening position) and a lowered position (a valve closing position). That is, the rotary motor 172 functions as a common drive source of the float contact member 178 and the valve body 182 (the shut-off valve 180). Further, upon activation of the rotary motor 172, the float contact member 178 moves in a direction opposite to the valve body 182 because the helical direction of the upper threaded shaft 174 is different from the lower threaded shaft 175.

The rotary motor 172 is electrically connected to the ECU 17, so as to be controlled based on the signal from the ECU 17. As shown in FIG. 16, in a condition in which the valve body 182 is in the valve closing position (shown by solid lines) while the float contact member 178 is in the elevated position (shown by solid lines), when the rotary motor 172 is activated in a forward direction, the float contact member 178 is lowered to press the float 43 downward (shown by chain double dashed lines) while the valve body 182 moves upward to open the shut-off valve 180 (shown by chain double dashed lines). In this condition, when the rotary motor 172 is activated in a reverse direction, the float contact member 178 moves upward so as to be spaced apart from press the float 43 (shown by solid lines) while the valve body 182 is lowered to close the shut-off valve 180 (shown by solid lines). Further, the rotary motor 172 may be activated such that the float contact member 178 is held on an intermediate position between the elevated position and the lowered position thereof while the valve body 182 is held on an intermediate position between the elevated position and the lowered position thereof.

The full tank fuel level limiting valve device 170 of the sixth embodiment has substantially the same function and effects as the full tank fuel level limiting valve device 130 (FIG. 11) of the fifth embodiment.

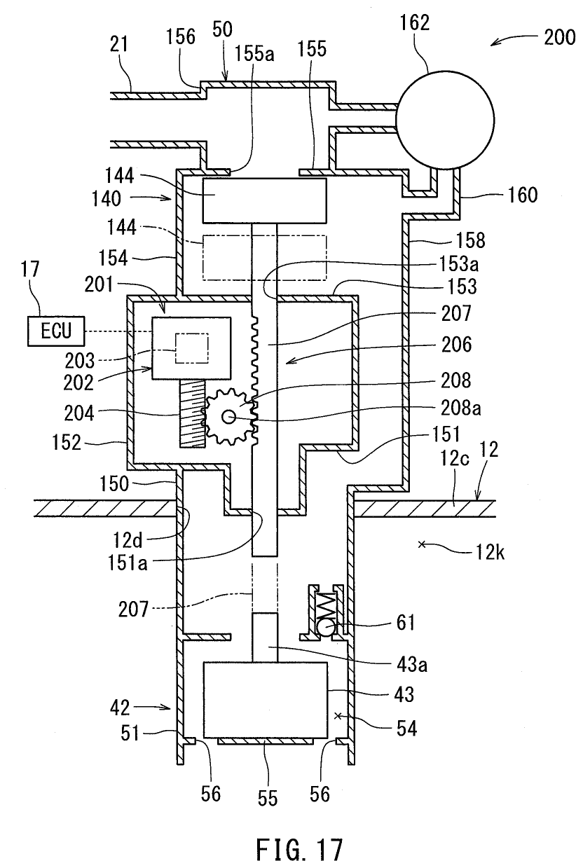

Next, a seventh detailed representative embodiment of the present disclosure will be described with reference to FIG. 17. Because the seventh embodiment relates to the fifth embodiment, only the constructions and elements that are different from the fifth embodiment will be explained in detail. In particular, as shown in FIG. 17, this embodiment may be different from the fifth embodiment in that the full tank fuel level limiting valve device 130 is replaced with a full tank fuel level limiting valve device 200.

As shown in FIG. 17, in the full tank fuel level limiting valve device 200 of this embodiment, the electrically driven actuator 131 of the fifth embodiment is replaced with an electrically driven actuator 201 (which may be simply referred to as “the actuator”). The electrically driven actuator 201 includes an electric rotary motor 202 (which may be referred to as “the electric motor”) disposed in the third casing portion 152 (which is slightly modified in shape in this embodiment). The rotary motor 202 includes a rotor 203. However, the upper threaded shaft 134, the lower threaded shaft 135 and the float contact member 138 are omitted. Instead, the rotary motor 202 includes a worm gear 204 rotatable with the rotor 203 and a rack-and-pinion mechanism 206 to change a rotational movement to a reciprocal movement.

The rack-and-pinion mechanism 206 includes a rack 207 (which may be referred to as “the valve closure prevention member”) and a pinion 208. The rack 207 is held on the second casing portion 152 so as to be vertically movable without rotating around an axis thereof. The rack 207 is projected upward and extends into the fourth casing portion 154 through the through hole 153a of the partition wall 153. An upper end of the rack 207 is connected to the valve body (which is labeled by a reference numeral 144 in this embodiment) of the shut-off valve 140. Therefore, the valve body 144 may move vertically (upward and downward) with the rack 207. Further, the rack 207 projects downward and extends into the second casing portion 150 through the through hole 151a of the partition wall 151. Further, a distal (lower) end surface of the rack 207 is positioned vertically opposite to the distal (upper) end surface of the projection 43a of the float 43.

The pinion 208 is positioned between the worm gear 204 and the rack 207. The pinion 208 is rotatably held on the second casing portion 152 via a support shaft 208a. Further, the pinion 208 meshes with both of the worm gear 204 and the rack 207. Thus, a rotational movement of the rotary motor 202 can be changed to a reciprocal movement of the rack 207 via the worm gear 204 and the pinion 208.

The rotary motor 202 is electrically connected to the ECU 17, so as to be controlled based on the signal from the ECU 17. As shown in FIG. 17, in a condition in which the rack 207 is in an elevated position or waiting position (shown by solid lines) while the valve body 144 is in an elevated or valve closing position (shown by solid lines), when the rotary motor 202 is activated in a forward direction, the rack 207 is lowered to a lowered position via the worm gear 204 and the pinion 208. As a result, the valve body 144 is lowered to a lowered position to open the shut-off valve 140 while the lowered rack 207 contacts and presses the float 43 downward (shown by chain double dashed lines). In this condition, when the rotary motor 202 is activated in a reverse direction, the rack 207 moves upward via the worm gear 204 and the pinion 208. As a result, the valve body 144 moves upward to the elevated position to close the shut-off valve 140 while the lowered rack 207 is lifted up to the elevated position so as to be spaced apart from the float 43 (shown by solid lines). Further, the rotary motor 202 may be activated such that the rack 207 is held on an intermediate position between the elevated position and the lowered position thereof while the valve body 144 is held on an intermediate position between the elevated position and the lowered position thereof.

The full tank fuel level limiting valve device 200 of the seventh embodiment has substantially the same function and effects as the full tank fuel level limiting valve device 130 (FIG. 11) of the fifth embodiment.

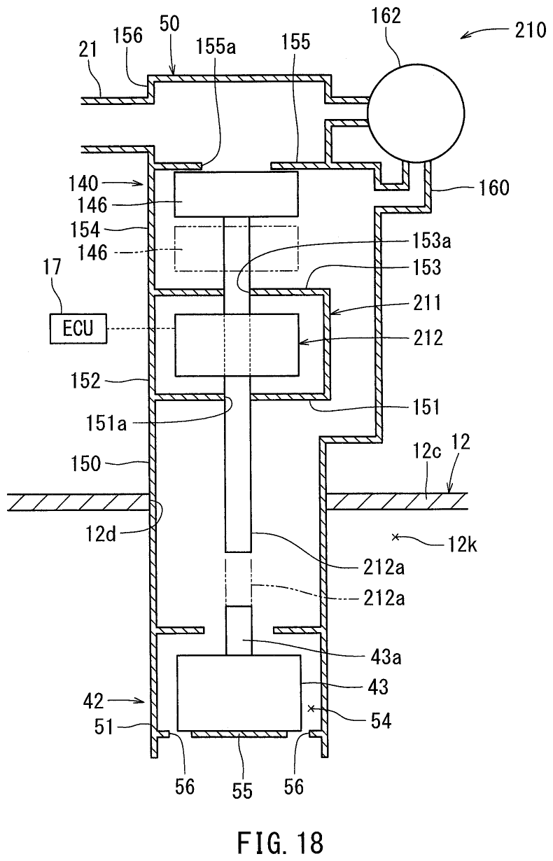

Next, an eighth detailed representative embodiment of the present disclosure will be described with reference to FIG. 18. Because the eighth embodiment relates to the fifth embodiment, only the constructions and elements that are different from the fifth embodiment will be explained in detail. In particular, as shown in FIG. 18, this embodiment may be different from the fifth embodiment in that the full tank fuel level limiting valve device 130 is replaced with a full tank fuel level limiting valve device 210.

As shown in FIG. 18, in the full tank fuel level limiting valve device 210 of this embodiment, the electrically driven actuator 131 of the fifth embodiment is replaced with an electrically driven actuator 211 (which may be simply referred to as “the actuator”). The electrically driven actuator 211 includes a linear solenoid 212 (which may be referred to as “the electric motor”). The linear solenoid 212 is disposed in the third casing portion 152. The linear solenoid 212 includes an axially (vertically) movable plunger 212a (which may be referred to as “the valve closure prevention member”). The plunger 212a is projected upward and downward from the linear solenoid 212.

An upper portion of the plunger 212a extends into the fourth casing portion 154 through the through hole 153a of the partition wall 153. Further, an upper end of the plunger 212a is connected to the valve body (which is labeled by a reference numeral 146 in this embodiment) of the shut-off valve 140. Therefore, the valve body 146 may move vertically (upward and downward) with the plunger 212a so as to close and open the valve orifice 155a of the partition wall 155. Conversely, a lower portion of the plunger 212a extends into the second casing portion 150 through the through hole 151a of the partition wall 151. Further, a distal (lower) end surface of the plunger 212a is positioned vertically opposite to the distal (upper) end surface of the projection 43a of the float 43.

The linear solenoid 212 is electrically connected to the ECU 17, so as to be controlled based on the signal from the ECU 17. As shown in FIG. 18, in a condition in which the plunger 212a is in an elevated position or waiting position (shown by solid lines) while the valve body 146 is in an elevated or valve closing position (shown by solid lines), when the linear solenoid 212 is turned on or energized, the plunger 212a is lowered to a lowered position. As a result, the valve body 146 is lowered to a lowered position to open the shut-off valve 140 while the plunger 212a contacts and presses the float 43 downward (shown by chain double dashed lines). In this condition, when the linear solenoid 212 is turned off or de-energized, the plunger 212a is returned to the elevated position. As a result, the valve body 146 moves upward to the elevated position to close the shut-off valve 140 while the plunger 212a is spaced apart from the float 43 (shown by solid lines).

The full tank fuel level limiting valve device 210 of the eighth embodiment has substantially the same function and effects as the full tank fuel level limiting valve device 130 (FIG. 11) of the fifth embodiment.

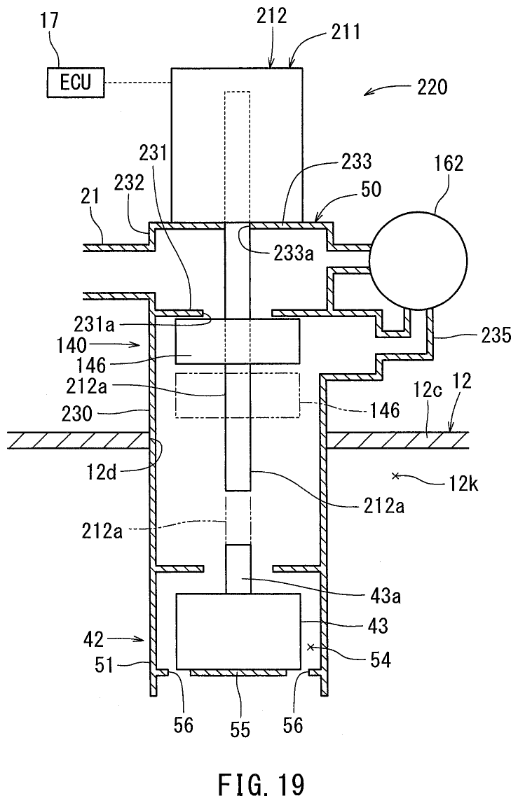

Next, a ninth detailed representative embodiment of the present disclosure will be described with reference to FIG. 19. Because the eighth embodiment relates to the eighth embodiment, only the constructions and elements that are different from the eighth embodiment will be explained in detail. In particular, as shown in FIG. 19, this embodiment may be different from the eighth embodiment in that the full tank fuel level limiting valve device 210 is replaced with a full tank fuel level limiting valve device 220, which is different from the full tank fuel level limiting valve device 210 in arrangement of the linear solenoid 212 and the shut-off valve 140.

As shown in FIG. 19, in the full tank fuel level limiting valve device 220 of the ninth embodiment, the casing 50 is modified. In particular, in the casing 50 of this embodiment, the second casing portion 150, the third casing portion 152, the fourth casing portion 154 and the fifth casing portion 156 of the eighth embodiment are replaced with a second casing portion 230 and a third casing portion 232. Further, the first to third casing portions 51, 230, 232 are arranged in this order from downward to upward. The second casing portion 230 is securely and hermetically coupled to the attaching opening 12d formed on the upper wall portion 12c of the fuel tank 12 in a condition in which the first casing portion 51 is introduced into the fuel tank 12. The third casing portion 232 is in fluid communication with the vapor conduit 21.

The second casing portion 230 is in fluid communication with the third casing portion 232 via a bypass conduit 235. The bypass conduit 235 is provided with the relief valve device 162. Further, the second casing portion 230 is separated from the third casing portion 232 by a partition wall 231 having a through hole or valve orifice 231a.

The linear solenoid 212 is disposed on an upper wall portion 233 of the third casing portion 232. The plunger 212a projects downward from the linear solenoid 212. The plunger 212a extends downward into the third casing portion 232 through a through hole 233a formed on the upper wall portion 233. The plunger 212a further extends downward into the second casing portion 230 through the valve orifice 231a of the partition wall 231. That is, the plunger 212a extends into the second casing portion 230 passing through the third casing portion 232. The valve body 146 of the shut-off valve 140 is disposed in the second casing portion 230. The valve body 146 is connected to the plunger 212a in a condition in which the plunger 212a penetrates the valve body 146. Therefore, the valve body 146 may move vertically (upward and downward) with the plunger 212a so as to close and open the valve orifice 231a of the partition wall 231.

The full tank fuel level limiting valve device 220 of the ninth embodiment has substantially the same function and effects as the full tank fuel level limiting valve device 210 (FIG. 18) of the eighth embodiment.

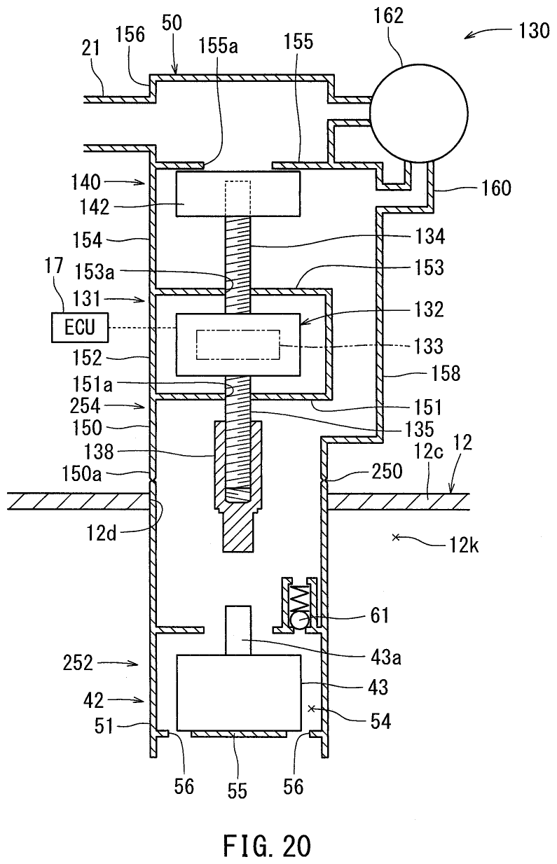

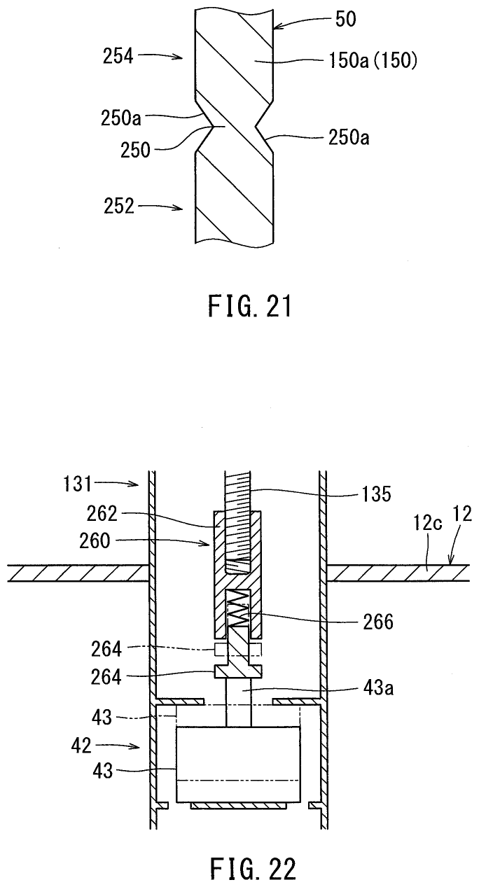

Next, a tenth detailed representative embodiment of the present disclosure will be described with reference to FIGS. 20 and 21. Because the tenth embodiment relates to the fifth embodiment, only the constructions and elements that are different from the fifth embodiment will be explained in detail. In particular, as shown in FIG. 20, this embodiment may be different from the fifth embodiment in that the casing 50 of the full tank fuel level limiting valve device 130 is partially modified.

As shown in FIG. 20, in this embodiment, the second casing portion 150 of the casing 50 includes an easily breakable weakened portion 250 formed on a circumferential wall portion 150a thereof. In particular, the weakened portion 250 is formed on a portion of the circumferential wall portion 150a positioned outside of the fuel tank 12. That is, the weakened portion 250 is positioned above the upper wall portion 12c of the fuel tank 12. Further, the weakened portion 250 is continuously formed over the entire circumference of the circumferential wall portion 150a. Thus, in this embodiment, the casing 50 is divided or segmented into two parts, i.e., a lower or first casing part 252 containing the full tank fuel level limiting valve 42 and coupled to the fuel tank 12 and an upper or second casing part 254 containing the actuator 131, at the weakened portion 250. Further, the first casing part 252 containing the full tank fuel level limiting valve 42 therein and the second casing part 254 containing the actuator 131 therein may respectively be referred to as a full tank fuel level limiting valve-side casing part and an actuator-side casing part.

As shown in FIG. 21, the weakened portion 250 is formed as a pair of annular grooves 250a each having a V-shaped cross section. The annular grooves 250a are respectively oppositely formed on inner and outer circumferential surfaces of the circumferential wall portion 150a. Thus, the weakened portion 250 is formed by partially thinning the circumferential wall portion 150a.

According to the tenth embodiment, when the upper casing part 254 is applied with an impact load as a result of a vehicle collision or other such accident, the weakened portion 250 formed on the casing 50 can be broken. As a result, the impact load can be effectively absorbed or dampened. Thus, the lower casing part 252 can be prevented from being damaged. As a result, the full tank fuel level limiting valve 42 included in the lower casing part 252 can be prevented from being subjected to the impact load. Therefore, the full tank fuel level limiting valve 42 (the float 43) can be protected from being damaged, so as to function as the fuel shut-off valve. Further, such a specific structure of this embodiment may be applied to any of the first to fourth embodiments and the sixth to ninth embodiments.

In this embodiment, the weakened portion 250 is continuously formed over the entire circumference of the circumferential wall portion 150a. However, the weakened portion 250 may be non-continuously formed on the circumferential wall portion 150a. Further, the weakened portion 250 may be replaced with a plurality of weakened portions continuously formed on the circumferential wall portion 150a and vertically (axially) arranged at intervals. Further, the annular grooves 250a may be replaced with a single annular groove formed on one of the inner and outer circumferential surfaces of the circumferential wall portion 150a. Each of the pair of annular grooves 250a may have a cross-sectional shape (e.g., U-shaped cross section) other than the V-shaped cross section.

Next, an eleventh detailed representative embodiment of the present disclosure will be described with reference to FIG. 22. Because the eleventh embodiment relates to the fifth embodiment, only the constructions and elements that are different from the fifth embodiment will be explained in detail. In particular, as shown in FIG. 22, this embodiment may be different from the fifth embodiment in that the float contact member 138 of the full tank fuel level limiting valve device 130 is replaced with a float contact member 260.

As shown in FIG. 22, the float contact member 260 includes an upper main portion 262, a lower movable portion (float contact portion) 264 and a spring 266 disposed between the main portion 262 and the movable portion 264. Similar to the float contact member 138 of the fifth embodiment, the main portion 262 is screwed on the lower threaded shaft 135 from below. The main portion 262 is held on the second casing portion 150 so as to be vertically movable without rotating around the axis thereof. Conversely, the movable portion 264 is vertically (axially) movably connected to the main portion 262 over a predetermined range of distance. The spring 266 is configured to bias the movable body 264 downward by a certain spring force with respect to the main portion 262. Such a spring force may be referred to as a valve closure prevention load of the valve closure prevention member. Further, the spring 266 is determined such that the spring force thereof is smaller than the buoyancy force that is applied to the float 43 by the fuel in the fuel tank 12 when the fuel tank 12 is filled up.

According to the eleventh embodiment, even in the condition in which the float contact member 260 (the lower movable portion 264) presses the float 43 downward in its lowered or acting position (shown by solid lines in FIG. 22), when the fuel tank 12 is filled up, the float 43 can move the movable portion 264 upward against the spring force of the spring 266. As a result, the valve orifice 58 can be closed by the float 43 (shown by chain double dashed lines in FIG. 22), so that the full tank fuel level limiting valve 42 can be closed. Therefore, when the fuel tank 12 is filled up, the float 43 can close the valve orifice 58 regardless of the position of the float contact member 260. Further, such a specific structure of this embodiment may be applied to any of the first to fourth embodiments and the sixth to ninth embodiments.

Representative examples of the present disclosure have been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detail description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. A fuel tank unit, comprising:
a fuel tank;
a canister configured to adsorb and desorb vapor generated in the fuel tank;
a vapor conduit in fluid communication with the fuel tank and the canister; and
a full tank fuel level limiting valve device connected to a fuel tank-side end of the vapor conduit,
wherein the full tank fuel level limiting valve device comprises a full tank fuel level limiting valve including a float that is configured to float due to a buoyancy force of fuel in the fuel tank so as to close the full tank fuel level limiting valve when the fuel tank is filled up, and an actuator configured to be activated due to a pressure difference between a tank inner pressure of the fuel tank and a pressure in the vapor conduit, and
wherein the actuator includes a valve closure prevention member that is configured to move and press the float when the actuator is activated, so as to prevent the float from moving in a valve closing direction.

2. The fuel tank unit of claim 1, wherein the actuator comprises a diaphragm actuator.

3. The fuel tank unit of claim 1, wherein the actuator comprises an air cylinder.

4. The fuel tank unit of claim 1, wherein the full tank fuel level limiting valve device includes a casing in which the full tank fuel level limiting valve and the actuator are contained disposed therein, and wherein the casing is provided with an easily breakable weakened portion formed between a first casing part containing the full tank fuel level limiting valve and connected to the fuel tank and a second casing part containing the actuator.

5. The fuel tank unit of claim 1, wherein the valve closure prevention member is configured such that a valve closure prevention load applied to the float thereby is smaller than the buoyancy force applied to the float when the fuel tank is filled up.

6. A fuel tank unit, comprising:
a fuel tank;
a canister configured to adsorb and desorb vapor generated in the fuel tank;
a vapor conduit in fluid communication with the fuel tank and the canister; and
a full tank fuel level limiting valve device connected to a fuel tank-side end of the vapor conduit,
wherein the full tank fuel level limiting valve device comprises a full tank fuel level limiting valve including a float that is configured to float due to a buoyancy force of fuel in the fuel tank so as to close the full tank fuel level limiting valve when the fuel tank is filled up, and an actuator including an electric motor that is configured to be activated based on a signal from an electronic control unit electrically connected thereto, and
wherein the actuator includes a valve closure prevention member that is configured to move and press the float when the electric motor is activated, so as to prevent the float from moving in a valve closing direction.

7. The fuel tank unit of claim 6, wherein the electric motor comprises a rotary motor.

8. The fuel tank unit of claim 7, wherein the actuator comprises a rack-and-pinion mechanism that is configured to change a rotational movement of the rotary motor to a reciprocal movement of the valve closure prevention member.

9. The fuel tank unit of claim 6, wherein the electric motor comprises a linear solenoid.

10. The fuel tank unit of claim 6, wherein the full tank fuel level limiting valve device includes a shut-off valve configured to open and close the vapor conduit, and wherein the electric motor is configured to function as a drive source of the shut-off valve.

11. The fuel tank unit of claim 6, wherein the full tank fuel level limiting valve device includes a casing in which the full tank fuel level limiting valve and the actuator are disposed therein, and wherein the casing is provided with an easily breakable weakened portion formed between a first casing part connected to the fuel tank and containing the full tank fuel level limiting valve and a second casing part containing the actuator.

12. The fuel tank unit of claim 6, wherein the valve closure prevention member is configured such that a valve closure prevention load applied to the float thereby is smaller than the buoyancy force applied to the float when the fuel tank is filled up.
